(19) United States
(12) Patent Application Publication
(10) Pub. No.: US 2026/0352562 A1
(43) Pub. Date: Nov. 5, 2026

(54) MODEL IDENTIFICATION METHOD AND DEVICE

(71) Applicant: Beijing Xiaomi Mobile Software Co., Ltd., Beijing (CN)

(72) Inventors: Qin MU, Beijing (CN); Xing YANG, Beijing (CN)

(73) Assignee: Beijing Xiaomi Mobile Software Co., Ltd., Beijing (CN)

(21) Appl. No.: 19/125,578

(22) PCT Filed: Nov. 3, 2022
(86) PCT No.: PCT/CN2022/129669

§ 371 Date: Apr. 29, 2025

(51) Int. Cl. H04L 41/16

(52) U.S. Cl. CPC H04L 41/16

(57) ABSTRACT

Disclosed in embodiments of the present application are a model identification method and a device, which can be applied to a communication system. The method comprises: a first node determines a first mapping relationship, wherein the first mapping relationship is a mapping relationship between a model and a first model identifier of the model, and the first model identifier is a local model identifier of the model on the first node; and the first node sends the first mapping relationship to a second node, and the second node determines, according to the first mapping relationship, a first model to be processed and performs related operations on the first model. The mapping between the model and the local model identifier of the model is established, the first mapping relationship is transmitted to the second node, and under the condition that the local model identifier is transmitted in a wireless network, the second node can determine the purpose of the identified model on the basis of the local model identifier, a global model identifier of the model does not need to be transmitted in the wireless network, the risk of tampering the global model identifier in transmission can be reduced, and the transmission time and the signaling overhead are reduced.

### TECHNICAL FIELD

The present disclosure relates to the field of communication technologies, and in particular to a method and apparatus for identifying a model.

### BACKGROUND

Machine learning models and/or Artificial Intelligence (AI) models are becoming widely used in wireless networks.

In order to facilitate the management and control of the models, a model Identity (ID) can be set for each model, which may be a globally unique identity. The model ID needs to be transmitted in model-related procedures such as model selection, model update, model activation and model deactivation. However, the globally unique model ID is not suitable for frequent transmission in the wireless networks.

### SUMMARY

Embodiments of the present disclosure provide a method and apparatus for identifying a model, which avoids transmitting a globally unique model identity of a model in a wireless network by transmitting a local model identity of the model in the wireless network.

In a first aspect, embodiments of the present disclosure provide a method for identifying a model, and the method includes:
determining a first mapping relationship, wherein the first mapping relationship is used by a second node to determine a first model required to be processed; and
sending the first mapping relationship to the second node.

In a second aspect, embodiments of the present disclosure provide another method for identifying a model, and the method includes:
receiving a first mapping relationship sent by a first node; and
determining, according to the first mapping relationship, a first model required to be processed, and performing a relevant operation on the first model.

In a third aspect, embodiments of the present disclosure provide another method for identifying a model, and the method includes:
receiving a first mapping relationship sent by a first node;
receiving a fourth message sent by a second node, wherein the fourth message is a message related to a first model required to be processed, and the fourth message includes a first model identity of the first model; and
determining a second model identity of the first model and/or the first model according to the first model identity of the first model and the first mapping relationship.

In embodiments of the present disclosure, the first node determines the first mapping relationship and sends the first mapping relationship to the second node, so that the second node can determine, according to the first mapping relationship, the first model required to be processed and perform the relevant operation on the first model. In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the model it identifies, thereby eliminating the need to transmit the global model identity of the model in the wireless network, which can not only reduce the risk of tampering the global model identity during transmission and provide the security of the model, but also reduce the transmission time and signaling overhead of the model identity transmission.

In a fourth aspect, embodiments of the present disclosure provide a communication device, which has part or all of functions for implementing the terminal device in the method according to the first aspect above. For example, the communication device may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

In a fifth aspect, embodiments of the present disclosure provide another communication device, which has part or all of functions for implementing the network device in the method examples according to the second aspect above. For example, the communication device may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

In a sixth aspect, embodiments of the present disclosure provide another communication device, which has part or all of functions for implementing the network device in the method examples according to the third aspect above. For example, the communication device may have functions as described in some or all the embodiments in the present disclosure, or may also have functions to separately implement any of embodiments in the present disclosure. The functions may be implemented by hardware, or may be implemented by executing corresponding software on the hardware. The hardware or the software includes one or more units or modules corresponding to the above functions.

In an implementation, a structure of the communication device may include a transceiving module and a processing module, and the processing module is configured to support the communication device to perform corresponding functions in the above method. The transceiving module is configured to support a communication between the communication device and other devices. The communication device may further include a storage module, which is configured to be coupled with the transceiving module and the processing module, and store necessary computer programs and data of the communication device.

In a seventh aspect, embodiments of the present disclosure provide a communication device, which includes a processor which, when invokes a computer program in a memory, executes the method according to the first aspect above.

In an eighth aspect, embodiments of the present disclosure provide a communication device, which includes a processor which, when invokes a computer program in a memory, executes the method according to the second aspect above.

In a ninth aspect, embodiments of the present disclosure provide a communication device, which includes a processor which, when invokes a computer program in a memory, executes the method according to the third aspect above.

In a tenth aspect, embodiments of the present disclosure provide a communication device, including a processor and a memory having a computer program stored thereon. The processor executes the computer program stored in the memory, to cause the communication device to implement the method according to the first aspect above.

In an eleventh aspect, embodiments of the present disclosure provide a communication device, including a processor and a memory having a computer program stored thereon. The processor executes the computer program stored in the memory, to cause the communication device to implement the method according to the second aspect above.

In a twelfth aspect, embodiments of the present disclosure provide a communication device, including a processor and a memory having a computer program stored thereon. The processor executes the computer program stored in the memory, to cause the communication device to implement the method according to the third aspect above.

In a thirteenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the first aspect above.

In a fourteenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the second aspect above.

In a fifteenth aspect, embodiments of the present disclosure provide a communication device, including a processor and an interface circuit. The interface circuit is configured to receive a code instruction and transmit the code instruction to the processor, and the processor is configured to run the code instruction to cause the device implement the method according to the third aspect above.

In a sixteenth aspect, embodiments of the present disclosure provide a computer-readable storage medium for storing instructions used by the above-mentioned terminal device. The instructions, when executed, cause the terminal device to implement the method according to the first aspect above.

In a seventeenth aspect, embodiments of the present disclosure provide a computer-readable storage medium for storing instructions used by the above-mentioned network device. The instructions, when executed, cause the network device to implement the method according to the second aspect above.

In an eighteenth aspect, embodiments of the present disclosure provide a computer-readable storage medium for storing instructions used by the above-mentioned network device. The instructions, when executed, cause the network device to implement the method according to the third aspect above.

In a nineteenth aspect, the present disclosure further provides a computer program product including a computer program which, when run on a computer, causes the computer to implement the method according to the first aspect above.

In a twentieth aspect, the present disclosure further provides a computer program product including a computer program which, when run on a computer, causes the computer to implement the method according to the second aspect above.

In a twenty-first aspect, the present disclosure further provides a computer program product including a computer program which, when run on a computer, causes the computer to implement the method according to the third aspect above.

In a twenty-second aspect, the present disclosure provides a chip system, which includes at least one processor and an interface, and is configured to support a terminal device to implement functions involved in the first aspect, for example, determining or processing at least one of data and information involved in the above method. In a possible design, the chip system further includes a memory for storing necessary computer programs and data of the terminal device. The chip system may consist of chips, or may include chips and other discrete devices.

In a twenty-third aspect, the present disclosure provides a chip system, which includes at least one processor and an interface, and is configured to support a network device to implement functions involved in the second aspect, for example, determining or processing at least one of data and information involved in the above method. In a possible design, the chip system further includes a memory for storing necessary computer programs and data of the network device. The chip system may consist of chips, or may include chips and other discrete devices.

In a twenty-fourth aspect, the present disclosure provides a chip system, which includes at least one processor and an interface, and is configured to support a network device to implement functions involved in the third aspect, for example, determining or processing at least one of data and information involved in the above method. In a possible design, the chip system further includes a memory for storing necessary computer programs and data of the network device. The chip system may consist of chips, or may include chips and other discrete devices.

In a twenty-fifth aspect, the present disclosure provides a computer program which, when run on a computer, causes the computer to implement the method according to the first aspect above.

In a twenty-sixth aspect, the present disclosure provides a computer program which, when run on a computer, causes the computer to implement the method according to the second aspect above.

In a twenty-seventh aspect, the present disclosure provides a computer program which, when run on a computer, causes the computer to implement the method according to the second aspect above.

### BRIEF DESCRIPTION OF THE DRAWINGS

In order to more clearly illustrate the technical solutions in embodiments of the present disclosure or the background technology, drawings that need to be used in embodiments of the present disclosure or the background technology will be described below.

FIG. 1 is a schematic architectural diagram of a communication system provided by an embodiment of the present disclosure;

FIG. 2 is a schematic flowchart of a method for identifying a model provided by an embodiment of the present disclosure;

FIG. 3 is a schematic flowchart of another method for identifying a model provided by an embodiment of the present disclosure;

FIG. 4 is a schematic flowchart of another method for identifying a model provided by an embodiment of the present disclosure;

FIG. 5 is a signaling interaction diagram of a method for identifying a model provided by an embodiment of the present disclosure;

FIG. 6 is a schematic flowchart of another method for identifying a model provided by an embodiment of the present disclosure;

FIG. 7 is a schematic flowchart of another method for identifying a model provided by an embodiment of the present disclosure;

FIG. 8 is a schematic flowchart of another method for identifying a model provided by an embodiment of the present disclosure;

FIG. 9 is a schematic flowchart of another method for identifying a model provided by an embodiment of the present disclosure;

FIG. 10 is a schematic flowchart of another method for identifying a model provided by an embodiment of the present disclosure;

FIG. 11 is a signaling interaction diagram of a method for identifying a model provided by an embodiment of the present disclosure;

FIG. 12 is a schematic structural diagram of a communication device provided by an embodiment of the present disclosure;

FIG. 13 is a schematic structural diagram of a communication device provided by an embodiment of the present disclosure; and

FIG. 14 is a schematic structural diagram of a chip provided by an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. Implementations set forth in the following description of the embodiments do not represent all implementations consistent with the present disclosure. Instead, they are merely examples of apparatuses and methods consistent with some aspects related to the present disclosure as recited in the appended claims.

The terms used in embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “upon” or “when” or “in response to determination”. For the purpose of brevity and ease of understanding, the terms used herein when the size relationship is characterized are “greater than” or “less than”, “higher than” or “lower than”. However, for those skilled in the art, it can be understood that the term “greater than” also covers the meaning of “greater than or equal to”, and “less than” also covers the meaning of “less than or equal to”; the term “higher than” covers the meaning of “higher than or equal to”, and “lower than” also covers the meaning of “lower than or equal to”.

In order to better understand a method for identifying a model disclosed in embodiments of the present disclosure, a communication system to which the embodiments of the present disclosure are applicable is first described below.

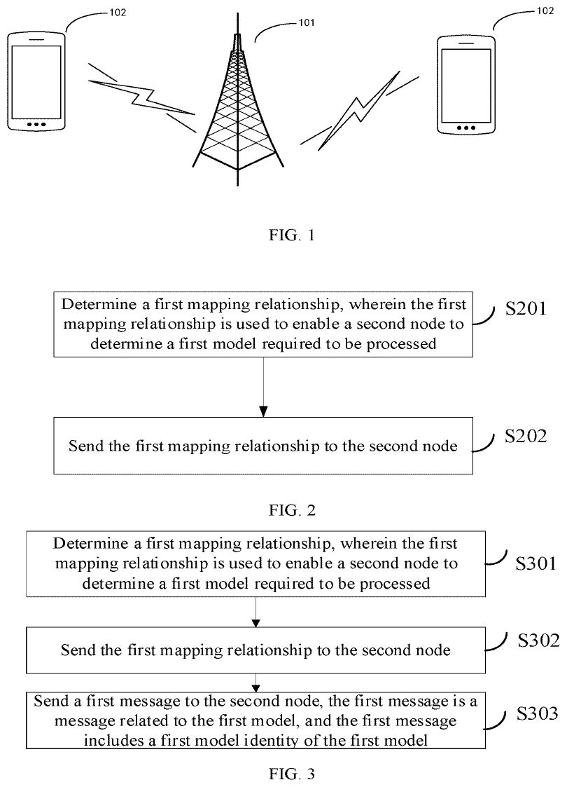

FIG. 1 is a schematic architectural diagram of a communication system provided by an embodiment of the present disclosure. Referring to FIG. 1, the communication system may include, but is not limited to, one network device and one terminal device. The number and forms of devices shown in FIG. 1 are only as an example and do not constitute a limitation on embodiments of the present disclosure. The communication system may include two or more network devices, two or more terminal devices in practical applications. As an example for illustration, the communication system shown in FIG. 1 includes one network device 101and two terminal devices 102.

It should be noted that the technical solutions of embodiments of the present disclosure may be applied to various communication systems, for example, a third generation (3G) universal mobile communication system (UMTS), a long term evolution (LTE) system, a 5th generation (5G) mobile communication system, a 5G new radio (NR) system, a 6th generation (6G) mobile communication system, or other future new mobile communication systems. It should also be noted that the sidelink in embodiments of the present disclosure can also be called a side link or a direct link.

The network device 101 in embodiments of the present disclosure may include an entity on a network side for transmitting or receiving signals. For example, the network device 101 may be an evolved NodeB (eNB), a transmission reception point (TRP), a next generation NodeB (gNB) in a NR system, a base station in other future mobile communication systems, or an access node in a wireless fidelity (WiFi) system. Embodiments of the present disclosure do not limit the specific technology and specific device form adopted by the network device. The network device provided by embodiments of the present disclosure may be composed of a central unit (CU) and a distributed unit (DU). The CU may also be called a control unit. Using the CU-DU structure allows to split a protocol layer of the network device, such as the base station, a part of functions of the protocol layer is centrally controlled in the CU, some or all of the remaining functions of the protocol layer are distributed in the DU, and the CU centrally controls the DU.

The terminal device 102 in embodiments of the present disclosure is an entity on a user side for receiving or transmitting signals, such as a mobile phone. The terminal device may also be called a terminal, a user equipment (UE), a mobile station (MS), a mobile terminal (MT), and so on. The terminal device may be a car with a communication function, a smart car, a mobile phone, a wearable device, a tablet Pad, a computer with a wireless transceiving function, a virtual reality (VR) terminal device, an augmented reality (AR) terminal device, a wireless terminal device in an industrial control, a wireless terminal device in a self-driving, a wireless terminal device in a remote medical surgery, a wireless terminal device in a smart grid, a wireless terminal device in a transportation safety, a wireless terminal device in a smart city, a wireless terminal device in a smart home, etc. Embodiments of the present disclosure do not limit the specific technology and the specific device form adopted by the terminal device.

It can be understood that the communication system described in embodiments of the present disclosure is intended to more clearly illustrate the technical solutions of the embodiments of the present disclosure, and are not to be construed as limiting the technical solutions provided by the embodiments of the present disclosure. As will be apparent to those skilled in the art, with evolution of the network architecture and the emergence of new business scenarios, the technical solutions provided by the embodiments of the present disclosure are equally applicable to similar technical problems.

It should be noted that a method for identifying a model provided in any embodiment of the present disclosure can be executed alone, or in combination with implementations in other embodiments, or in combination with any technical solution in the related arts.

A method and apparatus for identifying a model provided by the present disclosure are described in detail below with reference to the accompanying drawings.

Reference is made to FIG. 2, which is a schematic flowchart of a method for identifying a model provided by an embodiment of the present disclosure. The method is executed by a first node, and as shown in FIG. 2, the method may include but is not limited to steps S201 and S202.

In the S201, a first mapping relationship is determined, and the first mapping relationship is used to enable a second node to determine a first model required to be processed.

In embodiments of the present disclosure, the model may be a machine learning model, an AI model, or other models or modeled configurations. For example, the model may include AI models such as Channel State Information (CSI) compression, positioning, and beam management, and these models may be applied to various communication nodes involved in the present disclosure, such as the first node, the second node, and a third node, which will not be described later.

In some implementations, the first mapping relationship may indicate:
a mapping relationship between a model and a first model identity of the model; or
a mapping relationship between a second model identity and the first model identity of the model,
the first model identity may be a local model identity of the model on the first node, and the second model identity is a global model identity of the model, such as a globally unique model identity of the model.

It can be understood that the first mapping relationship may include a mapping relationship between N models and first model identities of the N models, where N is a positive integer greater than or equal to 1. The mapping relationship in embodiments of the present disclosure has the same meaning as the relationship, indicating that there is a relationship between the model and the first model of the model.

In some implementations, the first node may generate the first mapping relationship based on a protocol agreement or indication.

In some other implementations, model configuration information may be obtained, and the first mapping relationship may be obtained from the model configuration information. That is, the first mapping relationship is carried in the model configuration information. It can be understood that the model configuration information may include relevant configurations of one or more models.

In some embodiments, the relevant configuration of each model may include a model and a first model identity corresponding thereto, that is, the relevant configuration of the model includes the first mapping relationship of the model. In some embodiments, the relevant configuration of each model includes a first model identity of a model and a second model identity corresponding thereto, that is, the relevant configuration of the model includes the first mapping relationship of the model. It should be understood that the above is only an example, and the method of representing the first mapping relationship is not limited thereto.

In embodiments of the present disclosure, the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity;
the first model identity being configured to uniquely identify the model in a radio access network, and the second model identity being configured to uniquely identify the model globally; or
the first model identity and the second model identity being both configured to determine the model.

It should be noted that there is a one-to-one correspondence between the model and the global model identity, and one global identity is used to uniquely identify one model. Each node among network nodes can determine the global model identity of the model by indication or pre-configuration. After determining the global model identity, the network node can determine the model corresponding to the identity.

It can be understood that in order to achieve the purpose of quickly transmitting the model identity, the first model identity can be a short model identity, that is, the number of bits occupied by the first model identity is lower than the number of bits occupied by the second model identity, thereby saving transmission resources and reducing signaling overhead.

In some implementations, the first model identity is one of the following layer identifiers: a Radio Resource Control (RRC) layer identifier, a Packet Data Convergence Protocol (PDCP) layer identifier, a Radio Link Control (RLC) layer identifier, a Media Access Control (MAC) layer identifier, or a physical layer identifier.

In the S202, the first mapping relationship is sent to the second node.

In an embodiment of the present disclosure, the first node may send the first mapping relationship to the second node, and the second node may save the first mapping relationship after receiving the first mapping relationship.

Furthermore, the second node may determine, based on the first mapping relationship, the first model required to be processed and perform a relevant operation on the first model.

In the present disclosure, “based on”, “according to” and “in consideration of” have the same meaning.

In embodiments of the present disclosure, the relevant operation may include at least one of the following operations: model selection, model update, model activation, model deactivation, model monitoring and model switching. This is only an example of the relevant operation and cannot be used as a condition to limit the present disclosure.

In embodiments of the present disclosure, the first node and the second node may be selected from at least one of the following combinations:
the first node being a gNB Central Unit (gNB-CU), and the second node being a gNB Distributed Unit (gNB-DU);
the first node being a gNB Central Unit Control Plane (gNB-CU-CP), and the second node being a gNB Central Unit User Plane (gNB-CU-UP);
the first node being a source base station, and the second node being a destination base station;
the first node being the base station, and the second node being a User Equipment (UE);
the first node being a core network node, and the second node being the base station; or
the first node being the core network node, and the second node being the UE.

In an example of the present disclosure, the first node may determine, according to network element types of the first node and the second node, a message used when transmitting the first mapping relationship between the first node and the second node.

In some implementations, the first node is the gNB-CU, the second node is the gNB-DU, and the first node may send the first mapping relationship to the second node through an F1 Application Protocol (F1AP) message.

In some other implementations, the first node is the gNB-CU-CP, the second node is the gNB-CU-UP, and the first node may send the first mapping relationship to the second node through an El Application Protocol (E1AP) message.

In some further implementations, the first node is the source base station, the second node is the destination base station, and the first node may send the first mapping relationship to the second node through an Xn Application Protocol (XnAP) message.

In some further implementations, the first node is the base station, the second node is the User Equipment (UE), and the first node sends the first mapping relationship to the second node through an RRC message or a User Plane (UP) message.

In some further implementations, the first node is the core network node, the second node is the base station, and the first node may send the first mapping relationship to the second node through an NG Application Protocol (NGAP) message.

In some further implementations, the first node is the core network node, the second node is the UE, and the first node may send the first mapping relationship to the second node through a Non-access stratum (NAS) message.

In embodiments of the present disclosure, the first node determines the first mapping relationship and sends the first mapping relationship to the second node, so that the second node can determine, according to the first mapping relationship, the first model required to be processed and perform the relevant operation on the first model. In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the model it identifies, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 3, which is a schematic flowchart of a method for identifying a model provided by an embodiment of the present disclosure. The method is executed by a first node, and as shown in FIG. 3, the method may include but is not limited to steps S301 to S303.

In the S301, a first mapping relationship is determined, and the first mapping relationship is used to enable a second node to determine a first model required to be processed.

The first mapping relationship may indicate:
a mapping relationship between a model and a first model identity of the model, or the first mapping relationship may be a mapping relationship between a second model identity and the first model identity of the model, the first model identity is a local model identity of the model on the first node, and the second model identity is a global model identity of the model, such as a globally unique model identity of the model.

For a detailed description of the step S301, reference may be made to the relevant contents in the above embodiments, which will not be repeated here.

In the S302, the first mapping relationship is sent to the second node.

For a detailed description of the step S302, reference may be made to the relevant contents in the above embodiments, which will not be repeated here.

In the S303, a first message is sent to the second node, the first message is a message related to the first model, and the first message includes a first model identity of the first model.

In an embodiment of the present disclosure, the first model is a model among one or more models included in the first mapping relationship, and the first model is a model determined by the first node that needs to be processed.

In an embodiment of the present disclosure, the first node may send the first message to the second node, and the first message may be the message related to the first model, the first message includes the first model identity of the first model, and the first model is indicated to the second node through the first model identity. In some embodiments, the first node determines the first model required to be processed, and determines the first model identity of the first model based on the first model and the first mapping relationship, and has the first model identity to be included in the first message and sends it to the second node.

In some implementations, the first model identity is one of the following layer identifiers: an RRC layer identifier, a PDCP layer identifier, an RLC layer identifier, a MAC layer identifier, or a physical layer identifier.

In an embodiment of the present disclosure, the first node sends the first model identity to the second node through the first message, and the first model identity may be the layer identifier. Accordingly, the first node sends the first model identity to the second node through at least one of the following signaling: RRC layer signaling, PDCP layer signaling, RLC layer signaling, MAC layer signaling, or physical layer signaling. That is, the first message may be at least one of the following signaling: the RRC layer signaling, the PDCP layer signaling, the RLC layer signaling, the MAC layer signaling, or the physical layer signaling.

In some embodiments, the PDCP layer signaling may be a PDCP control Protocol Data Unit (PDU). In some embodiments, the RLC layer signaling may be an RLC control PDU.

In some embodiments, the MAC layer signaling may include at least one of the following messages:
a Media Access Control-Control Element (MAC-CE), Downlink Control Information (DCI), Uplink Control Information (UCI), a random access request, and a random access feedback.

In some embodiments, the RRC layer signaling may be an RRC message.

It can be understood that the first message may also indicate to the second node one or more relevant operations that need to be performed on the first model.

After receiving the first message, the second node can determine, according to the first mapping relationship, the second model identity or the first model corresponding to the first model identity in the first message.

When the corresponding second model identity is determined, the identified model can be determined based on the second model identity, and the model identified by the second model identity is the first model. In some embodiments, the second node can determine, based on the first message, the one or more relevant operations that need to be performed on the first model, and perform the one or more relevant operations on the first model.

In some embodiments, the first node is a base station, the second node is a UE, and the first message sent by the first node to the second node is RRC signaling, MAC signaling, or physical layer signaling sent by the base station to the UE. It can be understood that the RRC layer signaling can be an RRC message; the MAC layer signaling can include at least one of a MAC-CE, DCI, UCI, a random access request, and a random access feedback.

In some implementations, the first mapping relationship and the first message may be sent together or separately. It can be understood that the first mapping relationship may be sent once and then sent again when the first mapping relationship is updated.

In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the model it identifies, thereby eliminating the need to transmit the global model identity of the model in the wireless network, which can not only reduce the risk of tampering the global model identity during transmission and provide the security of the model, but also reduce the transmission time and signaling overhead of the model identity transmission.

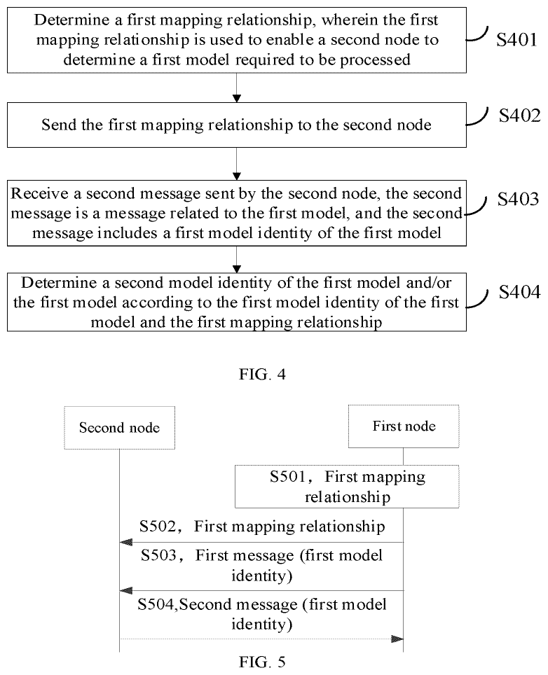

Reference is made to FIG. 4, which is a schematic flowchart of a method for identifying a model provided by an embodiment of the present disclosure. The method is executed by a first node, and as shown in FIG. 4, the method may include but is not limited to steps S401 to S404.

In the S401, a first mapping relationship is determined, and the first mapping relationship is used to enable a second node to determine a first model required to be processed.

The first mapping relationship may indicate:
a mapping relationship between a model and a first model identity of the model, or the first mapping relationship may be a mapping relationship between a second model identity and the first model identity of the model, the first model identity is a local model identity of the model on the first node, and the second model identity is a global model identity of the model, such as a globally unique model identity of the model.

For a detailed description of the step S401, reference may be made to the relevant contents in the above embodiments, which will not be repeated here.

In the S402, the first mapping relationship is sent to the second node.

For a detailed description of the step S402, reference may be made to the relevant contents in the above embodiments, which will not be repeated here.

In the S403, a second message sent by the second node is received, the second message is a message related to the first model, and the second message includes a first model identity of the first model.

In an embodiment of the present disclosure, the first model is a model among one or more models included in the first mapping relationship, and the first model is a model determined by the first node that needs to be processed.

In an embodiment of the present disclosure, the second node receives the first mapping relationship and saves the first mapping relationship. The second node may send the second message to the first node, and the second message may be the message related to the first model, the second message includes the first model identity of the first model, and the first model is indicated to the first node through the first model identity. In some embodiments, the second node determines the first model required to be processed, and determines the first model identity of the first model based on the first model and the first mapping relationship, and has the first model identity to be included in the second message and sends it to the first node.

In some implementations, the first model identity is one of the following layer identifiers: an RRC layer identifier, a PDCP layer identifier, an RLC layer identifier, a MAC layer identifier, or a physical layer identifier.

In an embodiment of the present disclosure, the first node sends the first model identity to the second node through the first message, and the first model identity may be a layer identifier. Accordingly, the first model identity is transmitted through at least one of the following signaling: RRC layer signaling, PDCP layer signaling, RLC layer signaling, MAC layer signaling, or physical layer signaling. That is, the second message may be at least one of the following signaling: the RRC layer signaling, the PDCP layer signaling, the RLC layer signaling, the MAC layer signaling, or the physical layer signaling.

In some embodiments, the PDCP layer signaling may be a PDCP control PDU. In some embodiments, the RLC layer signaling may be an RLC control PDU. In some embodiments, the MAC layer signaling may include at least one of a MAC-CE, DCI, UCI, a random access request and a random access feedback. In some embodiments, the RRC layer signaling may be an RRC message.

In the S404, a second model identity of the first model and/or the first model is determined according to the first model identity of the first model and the first mapping relationship.

It can be understood that the second message may also indicate to the first node one or more relevant operations that need to be performed on the first model.

After receiving the second message, the first node can determine, according to the first mapping relationship, the second model identity or the first model corresponding to the first model identity in the second message. When the corresponding second model identity is determined, the identified model can be determined based on the second model identity, and the model identified by the second model identity is the first model. In some embodiments, the first node can determine, according to the second message, the one or more relevant operations that need to be performed on the first model, and perform the one or more relevant operations on the first model.

In some embodiments, the first node is a base station, the second node is a UE, and the second message sent by the first node to the second node is RRC signaling, MAC signaling, or physical layer signaling sent by the base station to the UE. It can be understood that the RRC layer signaling can be an RRC message; the MAC layer signaling can include at least one of a MAC-CE, DCI, UCI, a random access request, and a random access feedback.

In the present disclosure, it is possible to transmit the local model identity in the wireless network, and the second node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

Based on the above embodiments, FIG. 5 is a signaling interaction diagram of a method for identifying a model provided by an embodiment of the present disclosure. As shown in FIG. 5, the method may include but is not limited to steps S501 to S504.

In the S501, a first node determines a first mapping relationship.

In the S502, the first node sends the first mapping relationship to a second node.

In the S503, the first node sends a first message to the second node.

In the S504, the first node receives a second message sent by the second node.

The steps S503 and S504 can be executed sequentially or in any order.

In the present disclosure, it is possible to transmit the local model identity in the wireless network, and the second node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

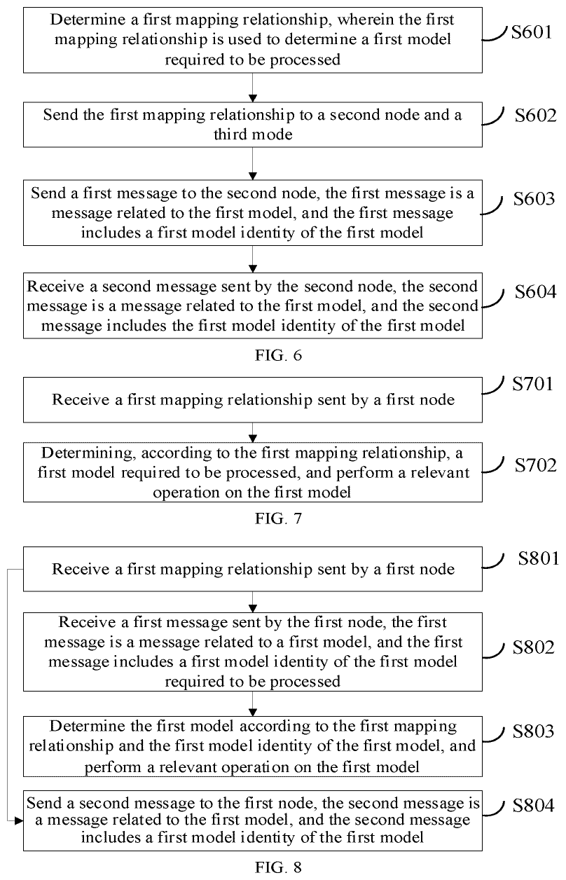

Reference is made to FIG. 6, which is a schematic flowchart of a method for identifying a model provided by an embodiment of the present disclosure. The method is executed by a first node, and as shown in FIG. 6, the method may include but is not limited to steps S601 to S604.

In the S601, a first mapping relationship is determined, and the first mapping relationship is used for a first model required to be processed.

The first mapping relationship may indicate: a mapping relationship between a model and a first model identity of the model, or the first mapping relationship may be a mapping relationship between a second model identity and the first model identity of the model, the first model identity is a local model identity of the model on the first node, and the second model identity is a global model identity of the model, such as a globally unique model identity of the model.

The first mapping relationship may be used to enable a second node and a third node to determine the first model that needs to be processed.

For a detailed description of the step S601, reference may be made to the relevant contents in the above embodiments, which will not be repeated here.

In the S602, the first mapping relationship is sent to the second node and the third node.

In a separation architecture or multi-connectivity (including Dual Connectivity (DC)) scenario, the second node and the third node need to exchange a message related to the first model. In an embodiment of the present disclosure, the first node can send the first mapping relationship to the second node and the third node. After receiving the first mapping relationship, the second node and the third node can save the first mapping relationship.

In some implementations, the first node and the third node are both base stations, and the second node is a UE.

In some other implementations, the first node is a CU, the second node is a UE, and the third node is a DU. In some embodiments, the CU may be a gNB-CU, and the DU may be a gNB-DU, the first mapping relationship may be carried in an F1 AP message sent by the gNB-CU to the gNB-DU, and the FIAP message may be a UE context setup request message or a UE context modification request message, but is not limited thereto.

In some further implementations, the first node is a Master Node (MN), the second node is a UE, and the third node is a Secondary Node (SN). The first mapping relationship is carried in an XnAP message sent by the MN to the SN, and the XnAP message may be a SN addition request message or a SN modification request message, but is not limited thereto.

The method for identifying the model provided in an embodiment of the present disclosure may also include the steps S603 and S604.

In the S603, a first message is sent to the second node, the first message is a message related to the first model, and the first message includes a first model identity of the first model.

In the S604, a second message sent by the second node is received, the second message is a message related to the first model, and the second message includes a first model identity of the first model.

The steps S603 and S604 can be executed sequentially or in any order.

In embodiments of the present disclosure, the first node determines the first mapping relationship and sends the first mapping relationship to the second node and the third node, so that the second node and the third node can determine, according to the first mapping relationship, the first model required to be processed and perform the relevant operation on the first model. In the present disclosure, by establishing the mapping between the model and the local model identity of the model, and transmitting the first mapping relationship to the second node and the third node, it is possible to transmit the local model identity in the wireless network, and the second node and the third node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 7, which is a schematic flowchart of a method for identifying a model provided by an embodiment of the present disclosure. The method is executed by a second node, and as shown in FIG. 7, the method may include but is not limited to steps S701 and S702.

In the S701, a first mapping relationship sent by a first node is received.

The first mapping relationship is used to enable the second node to determine a first model required to be processed.

In embodiments of the present disclosure, the model may be a machine learning model, an AI model, or other models or modeled configurations.

In some implementations, the first mapping relationship may indicate: a mapping relationship between a model and a first model identity of the model; or a mapping relationship between a second model identity and the first model identity of the model. The first model identity may be a local model identity of the model on the first node, and the second model identity is a global model identity of the model, such as a globally unique model identity of the model.

It can be understood that the first mapping relationship may include a mapping relationship between N models and first model identities of the N models, where N is a positive integer greater than or equal to 1. The mapping relationship in embodiments of the present disclosure has the same meaning as the relationship, indicating that there is a relationship between the model and the first model of the model.

In some implementations, the first node may generate the first mapping relationship based on a protocol agreement or indication.

In some other implementations, model configuration information may be obtained, and the first mapping relationship may be obtained from the model configuration information. That is, the first mapping relationship is carried in the model configuration information. It can be understood that the model configuration information may include relevant configurations of one or more models.

In some implementations, in order to achieve the purpose of quickly transmitting the model identity, the first model identity may be a short model identity, thereby saving transmission resources and reducing signaling overhead.

In embodiments of the present disclosure, the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity;
the first model identity being configured to identify the model in a radio access network, and the second model identity being configured to identify the model globally; or
the first model identity and the second model identity being both configured to determine the model.

In some implementations, the first model identity is one of the following layer identifiers: an RRC layer identifier, a PDCP layer identifier, an RLC layer identifier, a MAC layer identifier, or a physical layer identifier.

In an embodiment of the present disclosure, the first node may send the first mapping relationship to the second node, and the second node may save the first mapping relationship after receiving the first mapping relationship.

In some implementations, the first node is a CU, the second node is a DU, and the second node may receive the first mapping relationship transmitted, through an F1AP message, by the first node.

In some implementations, the first node is a CU-CP, the second node is a CU-UP, and the second node may receive the first mapping relationship transmitted, through an EIAP message, by the first node.

In some implementations, the first node is a source base station, the second node is a destination base station, and the second node can receive the first mapping relationship transmitted, through an XnAP message, by the first node.

In some implementations, the first node is a base station, the second node is a User Equipment (UE), and the second node may receive the first mapping relationship transmitted, through an RRC message or a UP, by the first node.

In some implementations, the first node is a core network node, the second node is a base station, and the second node may receive the first mapping relationship transmitted, through an NGAP message, by the first node.

In some implementations, the first node is a core network node, the second node is a UE, and the second node may receive the first mapping relationship transmitted, through a NAS message, by the first node.

In the S702, a first model required to be processed is determined according to the first mapping relationship, and a relevant operation is performed on the first model.

In an embodiment of the present disclosure, the second node may determine, based on the first mapping relationship, the first model required to be processed, and perform the relevant operation on the first model.

In an embodiment of the present disclosure, the relevant operation may include at least one of the following operations: model selection, model update, model activation, model deactivation and model switching.

In embodiments of the present disclosure, the second node receives the first mapping relationship sent by the first node, and the second node can determine, based on the first mapping relationship, the first model required to be processed, and perform the relevant operation on the first model. In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 8, which is a schematic flowchart of a method for identifying a model provided by an embodiment of the present disclosure. The method is executed by a second node, and as shown in FIG. 8, the method may include but is not limited to steps S801 to S804.

In the S801, a first mapping relationship sent by a first node is received.

The first mapping relationship is used to enable the second node to determine the first model required to be processed.

In some implementations, the first mapping relationship may indicate: a mapping relationship between a model and a first model identity of the model; or a mapping relationship between a second model identity and the first model identity of the model. The first model identity may be a local model identity of the model on the first node, and the second model identity is a global model identity of the model, such as a globally unique model identity of the model.

For a detailed description of the step S801, reference may be made to the relevant contents in the above embodiments, which will not be repeated here.

In the S802, a first message sent by the first node is received, the first message is a message related to a first model, and the first message includes a first model identity of the first model required to be processed.

In an embodiment of the present disclosure, the first model is a model among one or more models included in the first mapping relationship, and the first model is a model determined by the first node that needs to be processed.

In an embodiment of the present disclosure, the first node determines the first model required to be processed, and determines the first model identity of the first model based on the first model and the first mapping relationship, and has the first model identity to be included in the first message and sends it to the second node. Accordingly, the second node can receive the first message sent by the first node.

Regarding the specific process of the first node sending the first message to the second node, reference may be made to the relevant contents in the above embodiments, which will not be repeated here.

In the S803, the first model is determined according to the first mapping relationship and the first model identity of the first model, and a relevant operation is performed on the first model.

It can be understood that the first message may also indicate to the second node one or more relevant operations that need to be performed on the first model.

After receiving the first message, the second node can determine, according to the first mapping relationship, the second model identity or the first model corresponding to the first model identity in the first message.

When the corresponding second model identity is determined, the identified model can be determined based on the second model identity, and the model identified by the second model identity is the first model. In some embodiments, the second node can determine, based on the first message, the one or more relevant operations that need to be performed on the first model, and perform the one or more relevant operations on the first model.

In the S804, a second message is sent to the first node, the second message is a message related to the first model, and the second message includes a first model identity of the first model.

In an embodiment of the present disclosure, the second node receives the first mapping relationship and saves the first mapping relationship. The second node may send the second message to the first node, and the second message may be the message related to the first model, the second message includes the first model identity of the first model, and the first model is indicated to the first node through the first model identity. In some embodiments, the second node determines the first model required to be processed, and determines the first model identity of the first model based on the first model and the first mapping relationship, and has the first model identity to be included in the second message and sends it to the first node.

Regarding the specific process of the second node sending the second message to the first node, reference may be made to the relevant contents in the above embodiments, which will not be repeated here.

Accordingly, after receiving the second message, the first node can determine, according to the first mapping relationship, the second model identity or the first model corresponding to the first model identity in the second message, and perform one or more relevant operations indicated by the second message on the first model.

The steps S802 and S804 can be executed sequentially or in any order.

In some implementations, the first node is a base station, the second node is a UE, and the first message and/or the second message is RRC layer signaling, MAC layer signaling, or physical layer signaling sent by the base station to the UE. It can be understood that the RRC layer signaling can be an RRC message; the MAC layer signaling can include at least one of a MAC-CE, DCI, UCI, a random access request, and a random access feedback.

In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

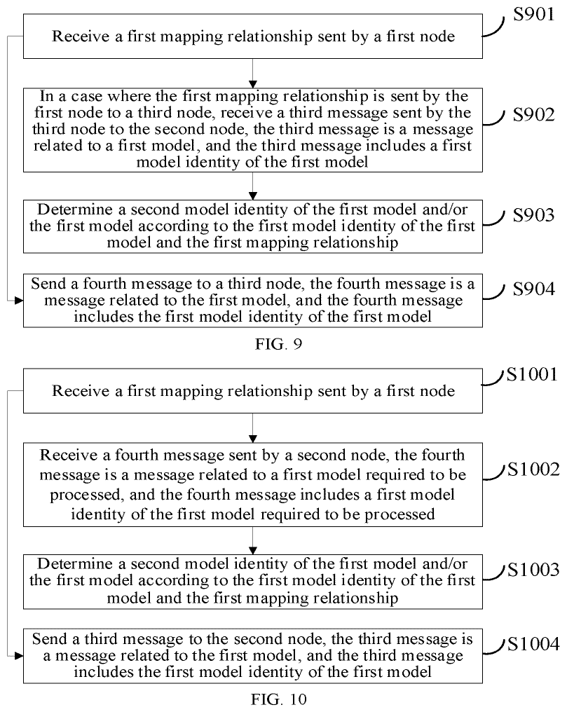

Reference is made to FIG. 9, which is a schematic flowchart of a method for identifying a model provided by an embodiment of the present disclosure. The method is executed by a second node, and as shown in FIG. 9, the method may include but is not limited to steps S901 to S904.

In the S901, a first mapping relationship sent by a first node is received.

The first mapping relationship is used to enable the second node and a third node to determine a first model that needs to be processed.

In some implementations, the first mapping relationship may indicate: a mapping relationship between a model and a first model identity of the model; or a mapping relationship between a second model identity and the first model identity of the model. The first model identity may be a local model identity of the model on the first node, and the second model identity is a global model identity of the model, such as a globally unique model identity of the model.

For a detailed description of the step S901, reference may be made to the relevant contents in the above embodiments, which will not be repeated here.

In the S902, in a case where the first node sends the first mapping relationship to the third node, a third message sent by the third node to the second node is received, the third message is a message related to the first model, and the third message includes a first model identity of the first model.

In a separation architecture or multi-connectivity (such as DC) scenario, the second node and the third node need to exchange the message related to the first model. In an embodiment of the present disclosure, the first node can send the first mapping relationship to the second node and the third node. After receiving the first mapping relationship, the second node and the third node save the first mapping relationship.

In some implementations, the first node and the third node are both base stations, and the second node is a UE.

In some other implementations, the first node is a CU, the second node is a UE, and the third node is a DU. In some embodiments, the CU may be a gNB-CU, and the DU may be a gNB-DU, the first mapping relationship may be carried in an F1AP message sent by the gNB-CU to the gNB-DU, and the F1AP message may be a UE context setup request message or a UE context modification request message, but is not limited thereto.

In some further implementations, the first node is a MN, the second node is a UE, and the third node is a SN. The first mapping relationship is carried in an XnAP message sent by the MN to the SN, and the XnAP message may be a SN addition request message or a SN modification request message, but is not limited thereto.

In an embodiment of the present disclosure, the third node receives the first mapping relationship and saves the first mapping relationship. The third node may send a third message to the second node. In some embodiments, the third node determines the first model required to be processed, and determines the first model identity of the first model according to the first model and the first mapping relationship, and has the first model identity to be included in the third message and sends it to the second node.

In the S903, a second model identity of the first model and/or the first model is determined according to the first model identity of the first model and the first mapping relationship.

After receiving the third message, the second node can determine, according to the first mapping relationship, the second model identity or the first model corresponding to the first model identity in the third message, and perform one or more relevant operations indicated by the second message on the first model.

In the S904, a fourth message is sent to the third node, the fourth message is a message related to the first model, and the fourth message includes the first model identity of the first model.

In an embodiment of the present disclosure, the second node determines the first model required to be processed, and determines the first model identity of the first model based on the first model and the first mapping relationship, and has the first model identity to be included in the fourth message and sends it to the third node. Accordingly, after receiving the fourth message, the third node can determine, according to the first mapping relationship, the second model identity or the first model corresponding to the first model identity in the fourth message, and perform one or more relevant operations indicated by the fourth message on the first model.

The steps S902 and S904 can be executed sequentially or in any order.

In an example of the present disclosure, the second node can determine, according to network element types of the second node and the third node, a message used when transmitting the third message and/or the fourth message between the second node and the third node.

In some implementations, the second node is a UE, the third node is a base station or a SN, and the third message and/or the fourth message is RRC layer signaling, MAC signaling, or physical layer signaling.

In some other implementations, the second node is a UE, the third node is a gNB-DU, and the third message and/or the fourth message is the MAC signaling or the physical layer signaling.

It can be understood that the RRC layer signaling can be an RRC message; the MAC layer signaling can include at least one of a MAC-CE, DCI, UCI, a random access request, and a random access feedback.

In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 10, which is a schematic flowchart of a method for identifying a model provided by an embodiment of the present disclosure. The method is executed by a third node, and as shown in FIG. 10, the method may include but is not limited to steps S1001 to S1004.

S1001, a first mapping relationship sent by a first node is received.

The first mapping relationship is used to enable the second node and a third node to determine a first model that needs to be processed.

In some implementations, the first mapping relationship may indicate: a mapping relationship between a model and a first model identity of the model; or a mapping relationship between a second model identity and the first model identity of the model. The first model identity may be a local model identity of the model on the first node, and the second model identity is a global model identity of the model, such as a globally unique model identity of the model.

After receiving the first mapping relationship, the third node saves the first mapping relationship.

For the introduction of the first mapping relationship and the process of the first node sending the first mapping relationship to the third node, reference may be made to the relevant contents in the above embodiments, which will not be repeated here.

In the S1002, a fourth message sent by the second node is received, the fourth message is a message related to a first model required to be processed, and the fourth message includes a first model identity of the first model required to be processed.

In the S1003, a second model identity of the first model and/or the first model is determined according to the first model identity of the first model and the first mapping relationship.

After receiving the fourth message, the third node can determine, according to the first mapping relationship, the second model identity or the first model corresponding to the first model identity in the fourth message, and perform one or more relevant operations indicated by the second message on the first model.

The method for identifying the model provided by an embodiment of the present disclosure may further include a step S1004.

In the S1004, a third message is sent to the second node, the third message is a message related to the first model, and the third message includes a first model identity of the first model.

After receiving the third message, the second node can determine, according to the first mapping relationship, the second model identity or the first model corresponding to the first model identity in the third message, and perform one or more relevant operations indicated by the second message on the first model.

In some embodiments, the third node may determine, according to network element types of the second node and the third node, a message used when transmitting the third message and/or the fourth message between the third node and the second node.

In some implementations, the second node is a UE, the third node is a base station or a SN, and the third message and/or the fourth message is RRC layer signaling, MAC signaling, or physical layer signaling.

In some other implementations, the second node is a UE, the third node is a gNB-DU, and the third message and/or the fourth message is the MAC signaling or the physical layer signaling.

It can be understood that the RRC layer signaling can be an RRC message; the MAC layer signaling can include at least one of a MAC-CE, DCI, UCI, a random access request, and a random access feedback.

The steps S1002 and S1004 may be executed sequentially or in any order.

In embodiments of the present disclosure, it is possible to transmit the local model identity in the wireless network, and the local model identity can also identify the purpose of the model, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 11, which is a signaling interaction diagram of a method for identifying a model provided by an embodiment of the present disclosure. As shown in FIG. 11, the method may include but is not limited to steps S1101 to S1105.

In the S1101, a first node determines a first mapping relationship.

In the S1102, the first node sends the first mapping relationship to a second node.

In the S1103, the first node sends the first mapping relationship to a third node.

In the S1104, the second node receives a third message sent by the third node.

In the S1105, the second node sends a fourth message to the third node.

The steps S1104 and S1105 can be executed sequentially or in any order.

In embodiments of the present disclosure, by establishing the mapping between the model and the local model identity of the model, and transmitting the first mapping relationship to the second node and the third node, it is possible to transmit the local model identity in the wireless network, and the second node and the third node can also determine, based on the local model identity, the purpose of the identified model, thereby eliminating the need to transmit the global model identity of the model in the wireless network, which can not only reduce the risk of tampering the global model identity during transmission and provide the security of the model, but also reduce the transmission time and signaling overhead of the model identity transmission.

In the embodiments provided by the present disclosure, the method provided by the embodiments of the present disclosure is introduced from the perspectives of the first node, the second node and the third node. In order to realize various functions in the method provided by the embodiments of the present disclosure, the first node, the second node and the third node may include a hardware structure and a software module, and the functions are realized in the form of a hardware structure, a software module, or a hardware structure plus a software module. A function among the various functions can be executed in the form of a hardware structure, a software module, or a hardware structure plus a software module.

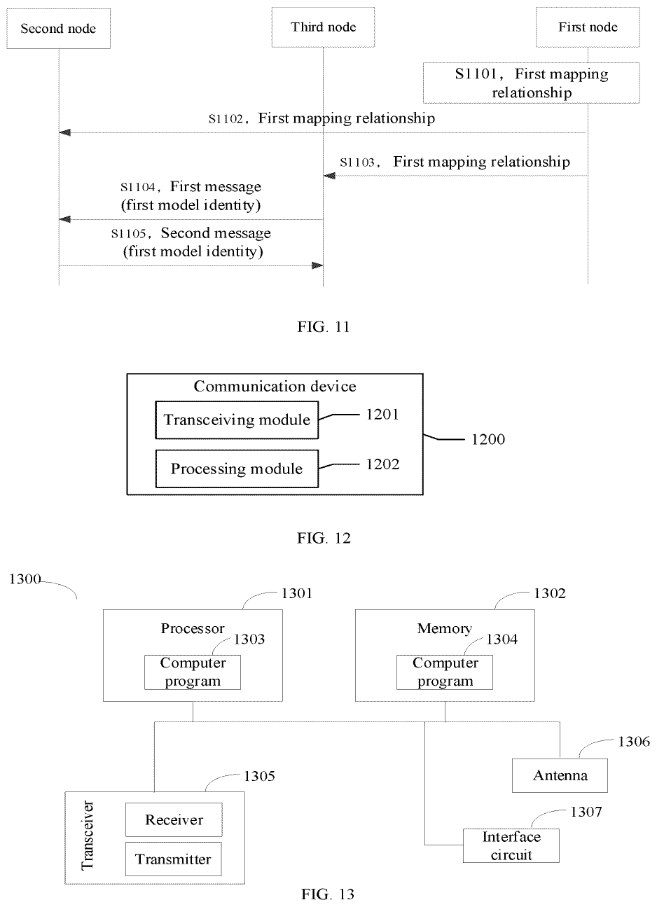

Reference is made to FIG. 12, which is a schematic structural diagram of a communication device 1200 provided by an embodiment of the present disclosure. The communication device 1200 shown in FIG. 12 may include a transceiving module 1201 and a processing module 1202. The transceiving module 1201 may include a transmitting module and/or a receiving module, the transmitting module is configured to implement a transmitting function, the receiving module is configured to implement a receiving function, and the transceiving module 1201 may implement the transmitting function and/or the receiving function.

The communication device 1200 may be a terminal device, a device in the terminal device, or a device that can be used in conjunction with the terminal device. Alternatively, the communication device 1200 may be a network device, a device in the network device, or a device that can be used in conjunction with the network device.

The communication device 1200 may be a first node, or a device in the first node, or a device that can be used in conjunction with the first node. Alternatively, the communication device 1200 may be a second node, or a device in the second node, or a device that can be used in conjunction with the second node. Alternatively, the communication device 1200 may be a second node, or a device in the second node, or a device that can be used in conjunction with the second node.

The communication device 1200 may be the first node in the above embodiments.

The processing module 1202 is configured to determine a first mapping relationship, and the first mapping relationship is used to enable a second node to determine a first model required to be processed.

The transceiving module 1201 is configured to send the first mapping relationship to the second node.

In some implementations, the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

In some implementations, the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity;
the first model identity being configured to identify the model in a radio access network, and the second model identity being configured to identify the model globally; or
the first model identity and the second model identity being both configured to determine the model.

In some implementations, the first node and the second node are selected from at least one of the following combinations:
the first node being a gNB Central Unit (gNB-CU), and the second node being a gNB Distributed Unit (gNB-DU);
the first node being a gNB Central Unit Control Plane (gNB-CU-CP), and the second node being a gNB Central Unit User Plane (gNB-CU-UP);
the first node being a source base station, and the second node being a destination base station;
the first node being a base station, and the second node being a User Equipment (UE);
the first node being a core network node, and the second node being the base station; or
the first node being the core network node, and the second node being the UE.

In some implementations, the transceiving module 1201 is further configured to:
when the first node is the CU, and the second node is the DU, send the first mapping relationship to the second node through an F1 Application Protocol (F1AP) message;
when the first node is the CU-CP, and the second node is the CU-UP, send the first mapping relationship to the second node through an E1AP message;
when the first node is the source base station, and the second node is the destination base station, send the first mapping relationship to the second node through an XnAP message;
when the first node is the base station, and the second node is the User Equipment (UE), send the first mapping relationship to the second node through a RRC message or a User Plane (UP);
when the first node is the core network node, and the second node is the base station, send the first mapping relationship to the second node through an NGAP message; or
when the first node is the core network node, and the second node is the UE, send the first mapping relationship to the second node through a NAS message.

In some implementations, a first model identity is one of the following layer identifiers: an RRC layer identifier, a Packet Data Convergence Protocol (PDCP) layer identifier, a Radio Link Control (RLC) layer identifier, a Media Access Control (MAC) layer identifier or a physical layer identifier.

In some implementations, the transceiving module 1201 is further configured to send the first model identity through at least one of the following signaling: RRC layer signaling, PDCP layer signaling, RLC layer signaling, MAC layer signaling or physical layer signaling.

In some implementations, the processing module 1202 is further configured to obtain model configuration information to obtain the first mapping relationship from the model configuration information.

In some implementations, the transceiving module 1201 is further configured to send a first message to the second node, wherein the first message is a message related to the first model, and the first message includes a first model identity of the first model.

In some implementations, the transceiving module 1201 is further configured to receive a second message sent by the second node, wherein the second message is a message related to the first model, and the second message includes a first model identity of the first model.

In some implementations, the processing module 1202 is further configured to determine a second model identity of the first model and/or the first model according to the first model identity of the first model and the first mapping relationship.

In some implementations, the processing module 1202 is further configured to perform a relevant operation on the first model.

In some implementations, the first node is a base station, the second node is a UE, and the first message and the second message may be RRC layer signaling, MAC layer signaling, or physical layer signaling.

In some implementations, the transceiving module 1201 is further configured to send the first mapping relationship to a third node in addition to sending the first mapping relationship to the second node in a separation architecture or a multi-connectivity scenario, wherein the second node and the third node need to exchange a message related to the first model.

In some implementations, the first node, the second node and the third node are selected from at least one of the following combinations:
the first node and the third node being both base stations, and the second node being a UE;
the first node being a CU, the second node being the UE, and the third node being a DU; or
the first node being a Master Node (MN), the second node being the UE, and the third node being a Secondary Node (SN).

The communication device 1200 may be the second node in the above embodiments.

The transceiving module 1201 is configured to receive a first mapping relationship sent by a first node.

The processing module 1202 is configured to determine, according to the first mapping relationship, a first model required to be processed.

In some implementations, the processing module 1202 is further configured to perform a relevant operation on the first model.

In some implementations, the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

In some implementations, the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity,
the first model identity being configured to identify the model in a radio access network, and the second model identity being configured to identify the model globally; or
the first model identity and the second model identity being both configured to determine the model.

In some implementations, the first node and the second node are selected from at least one of the following combinations:
the first node being a gNB Central Unit (gNB-CU), and the second node being a gNB Distributed Unit (gNB-DU);
the first node being a gNB Central Unit Control Plane (gNB-CU-CP), and the second node being a gNB Central Unit User Plane (gNB-CU-UP);
the first node being a source base station, and the second node being a destination base station;
the first node being a base station, and the second node being a User Equipment (UE);
the first node being a core network node, and the second node being the base station; or
the first node being the core network node, and the second node being the UE.

In some implementations, the transceiving module 1201 is further configured to:
when the first node is the CU, and the second node is the DU, receive the first mapping relationship sent, through an FAP message, by the first node;
when the first node is the CU-CP, and the second node is the CU-UP, receive the first mapping relationship sent, through an E1AP message, by the first node;
when the first node is the source base station, and the second node is the destination base station, receive the first mapping relationship transmitted, through an XnAP message, by the first node;
when the first node is the base station, and the second node is the User Equipment (UE), receive the first mapping relationship transmitted, through an RRC message or a UP, by the first node;
when the first node is the core network node, and the second node is the base station, receive the first mapping relationship transmitted, through an NGAP message, by the first node; or
when the first node is the core network node, and the second node is the UE, receive the first mapping relationship sent, through a NAS message, by the first node.

In some implementations, the second model identity is one of the following identifiers: an RRC layer identifier, a PDCP layer identifier, an RLC layer identifier, a MAC layer identifier, or a physical layer identifier.

In some implementations, the transceiving module 1201 is further configured to: receive, through at least one of the following signaling, the first model identity sent by the first node: RRC layer signaling, PDCP layer signaling, RLC layer signaling, MAC layer signaling or physical layer signaling.

In some implementations, the transceiving module 1201 is further configured to receive a first message sent by the first node, wherein the first message is a message related to the first model, and the first message includes a first model identity of the first model.

In some implementations, the processing module 1202 is further configured to determine a second model identity of the first model and/or the first model according to the first model identity of the first model and the first mapping relationship.

In some implementations, the transceiving module 1201 is further configured to send a second message to the first node, wherein the second message is a message related to the first model, and the second message includes a first model identity of the first model.

In some implementations, the first node is a base station, the second node is a UE, and the first message and/or the second message is RRC layer signaling, MAC layer signaling, or physical layer signaling.

In some implementations, the transceiving module 1201 is further configured to, in a case where the first mapping relationship is sent by the first node to a third node, receive a third message sent by the third node to the second node, wherein the third message is a message related to the first model, and the third message includes a first model identity of the first model; and
determine a second model identity of the first model and/or the first model according to the first model identity of the first model and the first mapping relationship.

In some implementations, the transceiving module 1201 is further configured to send a fourth message to a third node, wherein the fourth message is a message related to the first model, and the fourth message includes a first model identity of the first model.

In some implementations, the transceiving module 1201 is further configured to determine, according to network element types of the second node and the third node, a message used when the third message and/or the fourth message is transmitted between the second node and the third node.

In some implementations, the second node is a UE, the third node is a base station or a SN, and the third message and/or the fourth message is RRC layer signaling, MAC signaling, or physical layer signaling; and
the second node is the UE, the third node is a gNB-DU, and the third message and/or the fourth message is the MAC signaling or the physical layer signaling.

The communication device 1200 may be the third node in the above embodiments.

The transceiving module 1201 is configured to receive a first mapping relationship sent by a first node, and receive a fourth message sent by a second node, wherein the fourth message is a message related to a first model required to be processed, and the fourth message includes a first model identity of the first model.

The processing module 1202 is configured to determine the first model according to the first model identity of the first model and the first mapping relationship.

In some implementations, the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

In some implementations, the processing module 1202 is further configured to perform a relevant operation on the first model.

In some implementations, the transceiving module 1201 is further configured to send a third message to the second node, wherein the third message is a message related to the first model, and the third message includes the first model identity of the first model.

In some implementations, the second node is a UE, the third node is a base station or a SN, and the third message and/or the fourth message is an RRC message, MAC signaling, or physical layer signaling; and
the second node is a UE, the third node is a gNB-DU, and the third message and/or the fourth message is the MAC signaling or the physical layer signaling.

In embodiments of the present disclosure, the first node determines the first mapping relationship and sends the first mapping relationship to the second node, so that the second node can determine, according to the first mapping relationship, the first model required to be processed and perform the relevant operation on the first model. In the present disclosure, by establishing the mapping between the model and the local model identity of the model, and transmitting the first mapping relationship to the second node, it is possible to transmit the local model identity in the wireless network, and the second node can also determine, based on the local model identity, the purpose of the model it identifies, thereby eliminating the need to transmit the global model identity of the model in the wireless network, which can not only reduce the risk of tampering the global model identity during transmission and provide the security of the model, but also reduce the transmission time and signaling overhead of the model identity transmission.

Reference is made to FIG. 13, which is a schematic structural diagram of another communication device 1300 provided by an embodiment of the present disclosure. The communication device 1300 may be a first node, or a second node, or a third node, or a chip, a chip system, or a processor that supports the first node to implement the aforementioned method, or a chip, a chip system, or a processor that supports the second node to implement the aforementioned method, or a chip, a chip system, or a processor that supports the third node to implement the aforementioned method. The device may be configured to implement the method as described in the above method embodiments, and for details, reference may be made to the descriptions in the above method embodiments.

The communication device 1300 may include one or more processors 1301. The processor 1301 may be a general-purpose processor or a special-purpose processor. For example, it may be a baseband processor or a central processing unit. The baseband processor may be configured to process a communication protocol and communication data, and the central processing unit may be configured to control a communication device (such as a base station, a baseband chip, the terminal device, a terminal device chip, a DU or a CU, etc.) execute computer programs, and process data of computer programs.

In an embodiment, the communication device 1300 may further include one or more memories 1302 having stored therein a computer program 1304, and the processor 1301 executes the computer program 1304 to cause the communication device 1300 to implement the method as described in the above method embodiments. In an embodiment, the memory 1302 may have stored therein data. The communication device 1300 and the memory 1302 may be set separately or integrated together.

In an embodiment, the communication device 1300 may further include a transceiver 1305 and an antenna 1306. The transceiver 1305 may be called a transceiving unit, a transceiving machine, a transceiving circuit or the like, for implementing a transceiving function. The transceiver 1305 may include a receiver and a transmitter. The receiver may be called a receiving machine, a receiving circuit or the like, for implementing a receiving function. The transmitter may be called a sending machine, a sending circuit or the like for implementing a sending function.

In an embodiment, the communication device 1300 may further include one or more interface circuits 13013. The interface circuit 13013 is configured to receive a code instruction and transmit the code instruction to the processor 1301. The processor 1301 runs the code instruction to enable the communication device 1300 to execute the methods as described in the foregoing method embodiments.

The communication device 1300 is a terminal device and may be configured to perform functions of the terminal device in the above embodiments.

The communication device 1300 is a network device and may be configured to perform functions of the terminal device in the above embodiment.

In an implementation of the present disclosure, the processor 1301 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The transceiver circuit, interface or interface circuit can be used for reading and writing codes/data, or the transceiver circuit, interface or interface circuit can be used for signal transmission or transfer.

In an implementation of the present disclosure, the processor 1301 may be stored with a computer program 1303, and the computer program 1303 is performed by the processor 1301, causing the communication device 1300 to perform the method described in the above method embodiments. The computer program 1303 may be solidified in the processor 1301, in which case the processor 1301 may be implemented by hardware.

In an implementation of the present disclosure, the communication device 1300 may include a circuit, and the circuit may implement the functions of sending or receiving or communicating in the foregoing method embodiments. The processors and transceivers described in the present disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be the network device or the terminal device (e.g., the first terminal device in the above method embodiments), but the scope of the communication device described in the present disclosure is not limited thereto, and the structure of the communication device may not be limited by FIG. 13. The communication device may be a stand-alone device or may be part of a larger device. For example, the communication device may be:
(1) a stand-alone integrated circuit IC, or chip, or chip system or subsystem;
(2) a set of one or more ICs. In embodiments of the present disclosure, the IC set may further include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

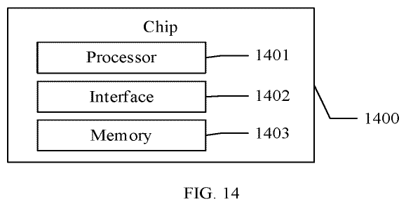

For the case where the communication device may be a chip or a chip system, reference may be made to a schematic structural diagram of a chip as shown in FIG. 14. The chip 1400 shown in FIG. 14 includes a processor 1401 and an interface 1402. In the chip, one or more processors 1401 may be provided, and more than one interface 1402 may be provided.

The chip 1400 can be configured to implement the functions of the first node in embodiments of the present disclosure. For a detailed description, reference is made to the relevant contents in the above embodiments, which will not be repeated here.

The chip 1400 can be configured to implement the functions of the second node in embodiments of the present disclosure. For a detailed description, reference is made to the relevant contents in the above embodiments, which will not be repeated here.

The chip 1400 can be configured to implement the functions of the first node in embodiments of the present disclosure. For a detailed description, reference is made to the relevant contents in the above embodiments, which will not be repeated here.

The chip 1400 further includes a memory 1403, which is configured to store necessary computer programs and data.

In embodiments of the present application, by specifying the frequency information type to report the interference frequency information, the terminal device and the network device can maintain consistency in the frequency information type used for the reported interference frequency information. The finer the granularity of the frequency information class, more signaling loss will be caused accordingly. In order to take into account the signaling loss and the fineness of frequency interference control, different frequency information types can be indicated to the terminal device to report the interference frequency information under different interference control requirements, so as to achieve a compromise between the signaling loss and the interference fine control. Furthermore, by setting the applicable conditions of the specified frequency information type, the accuracy of the reported interference frequency information is guaranteed, and the reporting amount of irrelevant frequency information can be excluded.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure further provide a communication system. The system includes the communication device as the terminal device and the communication device as the network device in the above embodiment of FIG. 7, or the system includes the communication device as the terminal device and the communication device as the network device in the above embodiments of FIG. 8.

The present disclosure further provides a readable storage medium on which instructions are stored. When the instructions are performed by a computer, the functions of any of the above method embodiments are implemented.

The present disclosure further provides a computer program product, which, when been performed by a computer, implements the functions of any of the above method embodiments.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

Those of ordinary skill in the art can understand that the first, second, and other numerical numbers involved in the present disclosure are only distinctions made for convenience of description and are not used to limit the scope of the embodiments of the disclosure, nor to indicate the order. At least one in the present disclosure can also be described as one or more, and the plurality can be two, three, four or more, which is not limited in the present disclosure. In an embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The correspondence shown in each table in the present disclosure may be configured or predefined. The values of information in each table are just examples, and may be configured as other values, which are not limited in the present disclosure. When configuring a correspondence between the information and various parameters, it is not necessary to configure all the correspondences shown in the tables. For example, the correspondences shown in some rows of the tables in the present disclosure may not be configured. For another example, appropriate deformations or adjustments (such as splitting, merging, and so on) can be made based on the above table. The names of parameters shown in the titles of the above tables may also adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, pre-definition, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above only describes some specific implementations of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

What is claimed is:

1. A method for identifying a model, performed by a first node, and comprising:
determining a first mapping relationship, wherein the first mapping relationship is used to enable a second node to determine a first model required to be processed; and
sending the first mapping relationship to the second node.

2. The method according to claim 1, wherein the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

3. The method according to claim 2, wherein the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity;
the first model identity being configured to identify the model in a radio access network, and the second model identity being configured to identify the model globally; or the first model identity and the second model identity being both configured to determine the model.

4. The method according to claim 1, wherein the first node and the second node are selected from at least one of the following combinations:
the first node being a gNB Central Unit (gNB-CU), and the second node being a gNB Distributed Unit (gNB-DU);
the first node being a gNB Central Unit Control Plane (gNB-CU-CP), and the second node being a gNB Central Unit User Plane (gNB-CU-UP);
the first node being a source base station, and the second node being a destination base station;
the first node being a base station, and the second node being a User Equipment (UE);
the first node being a core network node, and the second node being the base station; or
the first node being the core network node, and the second node being the UE.

5. The method according to claim 4, wherein sending the first mapping relationship to the second node comprises at least one of:
when the first node is the gNB-CU, and the second node is the gNB-DU, sending the first mapping relationship to the second node through an F1 Application Protocol (F1AP) message;
when the first node is the gNB-CU-CP, and the second node is the gNB-CU-UP, sending the first mapping relationship to the second node through an El Application Protocol (E1AP) message;
when the first node is the source base station, and the second node is the destination base station, sending the first mapping relationship to the second node through an Xn Application Protocol (XnAP) message;
when the first node is the base station, and the second node is the User Equipment (UE), sending the first mapping relationship to the second node through a Radio Resource Control (RRC) message or a User Plane (UP);
when the first node is the core network node, and the second node is the base station, sending the first mapping relationship to the second node through an NG Application Protocol (NGAP) message; or
when the first node is the core network node, and the second node is the UE, sending the first mapping relationship to the second node through a Non-access stratum (NAS) message.

6. The method according to claim 1, wherein a first model identity is one of the following layer identifiers: an RRC layer identifier, a Packet Data Convergence Protocol (PDCP) layer identifier, a Radio Link Control (RLC) layer identifier, a Media Access Control (MAC) layer identifier or a physical layer identifier.

7. The method according to claim 6, wherein the method further comprises:
sending the first model identity through at least one of the following signaling: RRC layer signaling, PDCP layer signaling, RLC layer signaling, MAC layer signaling or physical layer signaling.

8. The method according to claim 1, wherein the method further comprises:
obtaining model configuration information to obtain the first mapping relationship from the model configuration information.

9. The method according to any one of claims 1 to 8, wherein the method further comprises:
sending a first message to the second node, wherein the first message is a message related to the first model, and the first message comprises a first model identity of the first model.

10. The method according to any one of claims 1 to 8, wherein the method further comprises:
receiving a second message sent by the second node, wherein the second message is a message related to the first model, and the second message comprises a first model identity of the first model; and
determining a second model identity of the first model and/or the first model according to the first model identity of the first model and the first mapping relationship.

11. The method according to claim 10, wherein the method further comprises:
performing a relevant operation on the first model.

12. The method according to claim 9 or 10, wherein
when the first node is a base station, and the second node is a UE, the first message and/or the second message is selected from one of:
RRC layer signaling;
MAC layer signaling; or
physical layer signaling.

13. The method according to any one of claims 1 to 8, wherein the method further comprises:
sending the first mapping relationship to a third node in a separation architecture or a multi-connectivity scenario, wherein a message related to the first model is exchanged between the third node and the second node.

14. The method according to claim 13, wherein the first node, the second node and the third node are selected from at least one of the following combinations:
the first node and the third node being both base stations, and the second node being a UE;
the first node being a CU, the second node being the UE, and the third node being a DU; or
the first node being a Master Node (MN), the second node being the UE, and the third node being a Secondary Node (SN).

15. A method for identifying a model, performed by a second node, and comprising:
receiving a first mapping relationship sent by a first node; and
determining, according to the first mapping relationship, a first model required to be processed.

16. The method according to claim 15, wherein the method further comprises:
performing a relevant operation on the first model.

17. The method according to claim 15, wherein the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

18. The method according to claim 17, wherein the first model identity and the second model identity have at least one of the following characteristics:
signaling overhead of the second model identity being greater than signaling overhead of the first model identity;
a security protection mechanism being required by the second model identity, and the security protection mechanism being not required by the first model identity;
a transmission time of the first model identity being shorter than a transmission time of the second model identity;
the first model identity being configured to identify the model in a radio access network, and the second model identity being configured to identify the model globally; or
the first model identity and the second model identity being both configured to determine the model.

19. The method according to claim 15, wherein the first node and the second node are selected from at least one of the following combinations:
the first node being a Central Unit (CU), and the second node being a Distributed Unit (DU);
the first node being a Central Unit Control Plane (CU-CP), and the second node being a Central Unit User Plane (CU-UP);
the first node being a source base station, and the second node being a destination base station;
the first node being a base station, and the second node being a User Equipment (UE),
the first node being a core network node, and the second node being the base station; or
the first node being the core network node, and the second node being the UE.

20. The method according to claim 19, wherein the method further comprises:
when the first node is the CU, and the second node is the DU, receiving the first mapping relationship sent, through an F1AP message, by the first node;
when the first node is the CU-CP, and the second node is the CU-UP, receiving the first mapping relationship sent, through an EIAP message, by the first node;
when the first node is the source base station, and the second node is the destination base station, receiving the first mapping relationship transmitted, through an XnAP message, by the first node;
when the first node is the base station, and the second node is the User Equipment (UE), receiving the first mapping relationship transmitted, through an RRC message or a UP, by the first node;
when the first node is the core network node, and the second node is the base station, receiving the first mapping relationship transmitted, through an NGAP message, by the first node; or
when the first node is the core network node, and the second node is the UE, receiving the first mapping relationship sent, through a NAS message, by the first node.

21. The method according to claim 15, wherein a first model identity is one of the following identifiers: an RRC layer identifier, a PDCP layer identifier, an RLC layer identifier, a MAC layer identifier or a physical layer identifier.

22. The method according to claim 21, wherein the method further comprises:
receiving, through at least one of the following signaling, the first model identity sent by the first node: RRC layer signaling, PDCP layer signaling, RLC layer signaling, MAC layer signaling or physical layer signaling.

23. The method according to any one of claims 15 to 22, wherein the method further comprises:
receiving a first message sent by the first node, wherein the first message is a message related to the first model, and the first message comprises a first model identity of the first model; and
determining a second model identity of the first model and/or the first model according to the first model identity of the first model and the first mapping relationship.

24. The method according to any one of claims 15 to 22, wherein the method further comprises:
sending a second message to the first node, wherein the second message is a message related to the first model, and the second message comprises a first model identity of the first model.

25. The method according to claim 23 or 24, wherein:
when the first node is a base station and the second node is a UE, the first message and/or the second message is selected from one of:
RRC layer signaling;
MAC layer signaling;
physical layer signaling.

26. The method according to any one of claims 15 to 22, wherein the method further comprises:
in a case where the first mapping relationship is sent by the first node to a third node, receiving a third message sent by the third node to the second node, wherein the third message is a message related to the first model, and the third message comprises a first model identity of the first model; and
determining a second model identity of the first model and/or the first model according to the first model identity of the first model and the first mapping relationship.

27. The method according to any one of claims 15 to 22, wherein the method further comprises:
sending a fourth message to a third node, wherein the fourth message is a message related to the first model, and the fourth message comprises a first model identity of the first model.

28. The method according to claim 26 or 27, wherein the method further comprises:
determining, according to network element types of the second node and the third node, a message used when the third message and/or the fourth message is transmitted between the second node and the third node.

29. The method according to claim 28, wherein the method further comprises:
when the second node is a UE, and the third node is a base station or a SN, the third message and/or the fourth message is RRC layer signaling, MAC signaling or physical layer signaling;
when the second node is the UE, and the third node is a gNB-DU, the third message and/or the fourth message is the MAC signaling or the physical layer signaling.

30. A method for identifying a model, performed by a third node, and comprising:
receiving a first mapping relationship sent by a first node;
receiving a fourth message sent by a second node, wherein the fourth message is a message related to a first model required to be processed, and the fourth message comprises a first model identity of the first model; and
determining the first model according to the first model identity of the first model and the first mapping relationship.

31. The method according to claim 30, wherein the first mapping relationship indicates:
a mapping relationship between a model and a first model identity of the model; or
a mapping relationship between a second model identity and the first model identity of the model,
the first model identity is a local model identity of the model on the first node; and
the second model identity is a global model identity of the model.

32. The method according to claim 30, wherein the method further comprises:
performing a relevant operation on the first model.

33. The method according to claim 30, wherein the method further comprises:
sending a third message to the second node, wherein the third message is a message related to the first model, and the third message comprises the first model identity of the first model.

34. The method according to claim 33, wherein the method further comprises:
the second node is a UE, the third node is a base station or a SN, and the third message and/or the fourth message is an RRC message, MAC signaling, or physical layer signaling;
the second node is a UE, the third node is a gNB-DU, and the third message and/or the fourth message is the MAC signaling or the physical layer signaling.

35. A communication device, comprising:
a processing module, configured to determine a first mapping relationship, wherein the first mapping relationship is used to enable a second node to determine a first model required to be processed; and
a transceiving module, configured to send the first mapping relationship to the second node.

36. A communication device, comprising:
a transceiving module, configured to receive a first mapping relationship sent by a first node; and
a processing module, configured to determine, according to the first mapping relationship, a first model required to be processed.

37. A communication device, comprising:
a transceiving module, configured to receive a first mapping relationship sent by a first node, and receive a fourth message sent by a second node, wherein the fourth message is a message related to a first model required to be processed, and the fourth message comprises a first model identity of the first model; and
a processing module, configured to determine the first model according to the first model identity of the first model and the first mapping relationship.

38. A communication device, comprising a processor and a memory having a computer program stored thereon, wherein the processor executes the computer program stored in the memory to cause the communication device to perform the method according to any one of claims 1 to 14.

39. A communication device, comprising a processor and a memory having a computer program stored thereon, wherein the processor executes the computer program stored in the memory to cause the communication device to perform the method according to any one of claims 15 to 29.

40. A communication device, comprising a processor and a memory having a computer program stored thereon, wherein the processor executes the computer program stored in the memory to cause the communication device to perform the method according to any one of claims 30 to 34.

41. A communication device, comprising: a processor and an interface circuit;
the interface circuit is configured to receive a code instruction and transmit the code instruction to the processor; and
the processor is configured to run the code instruction to perform the method according to any one of claims 1 to 14.

42. A communication device, comprising: a processor and an interface circuit;
the interface circuit is configured to receive a code instruction and transmit the code instruction to the processor; and
the processor is configured to run the code instruction to perform the method according to any one of claims 15 to 29.

43. A communication device, comprising: a processor and an interface circuit;
the interface circuit is configured to receive a code instruction and transmit the code instruction to the processor; and
the processor is configured to run the code instruction to perform the method according to any one of claims 30 to 34

44. A computer-readable storage medium, configured to store instructions, which, when executed, implement the method according to any one of claims 1 to 14.

45. A computer-readable storage medium, configured to store instructions, which, when executed, implement the method according to any one of claims 15 to 29.

46. A computer-readable storage medium, configured to store instructions, which, when executed, implement the method according to any one of claims 30 to 34.
